(19) United States
(12) Patent Application Publication
(10) Pub. No.: US 2008/0130888 A1
(43) Pub. Date: Jun. 5, 2008

(54) Method And Apparatus For Generating Optical Pulses For Qkd

(75) Inventors: Alexei Trifonov, Boston, MA (US); Darius Subacius, Groton, MA (US)

Correspondence Address: OPTICUS IP LAW, PLLC, 7791 ALISTER MACKENZIE DRIVE, SARASOTA, FL, 34240, US

(73) Assignee: MAGIO TECHNOLOGIES, INC. a coporation

(21) Appl. No.: 11/662,560

(22) PCT Filed: Sep. 12, 2005
(86) PCT No.: PCT/US05/32474

§ 371 Date: Nov. 13, 2007

Related U.S. Application Data
(60) Provisional application No. 60/608,782, filed on Sep. 10, 2004.

(51) Int. Cl. H04K 1/00; H04L 9/00

(52) U.S. Cl. 380/256; 380/277

(57) ABSTRACT

Methods and apparatus for generating coherent optical pulses (P1′, P2′) in a quantum key distribution (QKD) station (Alice-N) of a QKD system (10) without using an optical fiber interferometer (12) are disclosed. The method includes generating a continuous wave (CW) beam of coherent radiation (R) having a coherence length LC and modulating the CW beam within the coherence length. The invention obviates the need for an interferometer loop to form multiple optical pulses from a single optical pulse, thereby obviating the need for thermal stabilization of the interferometer loop at the QKD station Alice-N.

### CLAIM OF PRIORITY

This application claims the benefit of priority under 35 U.S.C. § 119(e) of U.S. Provisional Application Ser. No. 60/608,782, filed on Sep. 10, 2004.

### TECHNICAL FIELD OF THE INVENTION

The present invention relates to quantum cryptography, and in particular relates to and has industrial utility in connection with a one-way quantum key distribution (QKD) system.

### BACKGROUND OF THE INVENTION

Quantum key distribution involves establishing a key between a sender (“Alice”) and a receiver (“Bob”) by using weak (e.g., 0.1 photon on average) optical signals transmitted over a “quantum channel.” The security of the key distribution is based on the quantum mechanical principle that any measurement of a quantum system in unknown state will modify its state. As a consequence, an eavesdropper (“Eve”) that attempts to intercept or otherwise measure the quantum signal will introduce errors into the transmitted signals and reveal her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). Specific QKD systems are described in publications by C. H. Bennett et al entitled “Experimental Quantum Cryptography” and by C. H. Bennett entitled “Quantum Cryptography Using Any Two Non-Orthogonal States”, Phys. Rev. Lett. 68 3121 (1992).

The general process for performing QKD is described in the book by Bouwmeester et al., “The Physics of Quantum Information,” Springer-Verlag 2001, in Section 2.3, pages 27-33. During the QKD process, Alice uses a random number generator (RNG) to generate a random bit for the basis (“basis bit”) and a random bit for the key (“key bit”) to create a qubit (e.g., using polarization or phase encoding) and sends this qubit to Bob.

The above mentioned publications by Bennett each describe a QKD system wherein Alice randomly encodes the polarization or phase of single photons at one end of the system, and Bob randomly measures the polarization or phase of the photons at the other end of the system. The QKD system described in the Bennett 1992 paper is based on two optical fiber Mach-Zehnder interferometers (one at Alice and one at Bob). Respective parts of the interferometric system are accessible by Alice and Bob so that each can control the phase of the interferometer.

FIG. 1 is a schematic diagram of a prior art QKD system 10 based on those disclosed in U.S. Pat. No. 5,307,410 to Bennett (“the Bennett patent”) and U.S. Pat. No. 5,953,421 to Townsend (“The Townsend patent), which patents are incorporated herein by reference. QKD system 10 includes two QKD stations Bob and Alice. Not shown in FIG. 1 are controllers in Alice and Bob that control the operation of their respective elements, and that are in operable communication with each another to coordinate the operation of the QKD system as a whole.

Alice includes a laser source L1 and a first interferometer loop 12 with arms 14 and 16 that have different lengths. One of the interferometer arms (say, 14) includes a modulator (polarization or phase) M1. Interferometer loop 12 is coupled to an optical fiber link FL, which is connected to a second interferometer loop 22 at Bob. Loop 22 includes arms 24 and 26 of different lengths with a phase modulator M2 in one of the arms (say arm 24). Loop 22 is coupled to a detector unit 30 via an optical fiber section F3. The detector unit 30 may include, for example, two single-photon detectors (SPDs) coupled to optical fiber section F3 by an optical coupler, such as illustrated and discussed in the Townsend patent. Detector unit 30 may also include a single SPD, such as illustrated and discussed in the Bennett patent.

In operation, laser source L1 generates a light pulse P0 that is divided into two pulses P1 and P2 by first interferometer loop 12. One of the pulses (say P1) travels over arm 14 and is randomly modulated polarization- or phase-modulated by modulator M1. The two pulses, which are now separated due to the different path lengths of the interferometer arms, are attenuated to so that they are weak (i.e., one or less photons per pulse on average). The photons then travel over fiber link FL to second interferometer loop 22.

At interferometer 22, each pulse P1 and P2 is then split into two pulses (P1 into P1a and P1b and P2 into P2a and P2b). Two of the pulses (say P1a and P2a) travel over arm 24, while the other two pulses (say P1b and P2b) travel over arm 26. One of these pulses (say, P2a) travels over arm 24 is randomly modulated by modulator M2.

The second interferometer loop then combines the pulses onto fiber section F3. If the two interferometer loops have the same path length (e.g., the lengths of arms 14 and 24 are the same and the lengths of arms 16 and 26 are the same), then the two pulses that travel the same optical path length (say, pulses P2a and P2b) interfere to create a single interfered pulse I. The other pulses enter fiber section F3 separated from one another because they followed optical paths of different lengths.

The interfered pulse I is then detected by detector unit 30 in a manner that reflects the phase or polarization imparted to the interfered pulse by modulators M1 and M2. The process is repeated to create a number of interfered pulses 1, which are detected and processed according to known QKD techniques to establish a secret key between Alice and Bob.

The use of an interferometer loop formed from optical fibers or beam splitters to create multiple pulses is standard in QKD systems. However, such arrangements tend to be lossy and are fairly complex because the loops have to be thermally stabilized. Further, there is a strict requirement for interferometer arm balancing. A laser LS1 normally has narrow pulses (for example, with full width at half maximum (FWHM) of approximately 100 ps), so the lengths of short-long arms should be balanced within an accuracy of hundreds of microns to obtain a good extinction ratio. Interfering pulses (e.g. P2a and P2b) should overlap in the time domain. In manufacturing, this puts strict requirements on fiber splicing and system component selection.

In addition, in a commercially viable QKD system, the interferometers at Alice and Bob should be manufactured together so that they are matched. This also puts limitations on practical system deployment and maintenance: if either the Alice or the Bob interferometer needs to be replaced, the other one needs to be replaced as well with a matching interferometer. Accordingly, it would be desirable to have another way to create the multiple coherent pulses at Alice with less loss and in a simpler manner that, for example, obviates the need for stabilizing one of the interferometers and the need for matching interferometers in the system.

### DESCRIPTION OF THE INVENTION

One aspect of the invention is a method of generating two or more coherent optical pulses in a first station of a QKD system. The method includes generating a continuous wave (CW) beam of coherent radiation having a coherence length LC and modulating the CW beam within the coherence length LC so as to create two or more coherent optical pulses of radiation. The method also includes sending the two or more coherent optical pulses as weak pulses to a second QKD station optically coupled to the first QKD station.

Another aspect of the invention is a QKD station of a QKD system. The QKD station includes a laser source adapted to emit a continuous wave (CW) beam of radiation having a coherence length LC. The station also includes a first modulator optically coupled to the laser source and adapted to modulate the radiation beam within the coherence length LC to create two or more coherent optical pulses. The station further includes a second modulator downstream of the first modulator and optically coupled thereto, the second modulator adapted to modulate at least one of the two or more coherent optical pulses.

### BRIEF DESCRIPTION OF THE DRAWINGS

FIG. 1 is a schematic diagram of a prior art QKD system; and

FIG. 2 is a schematic diagram of the pulse generation unit of the present invention as part of Alice in the QKD system illustrated in FIG. 1.

FIG. 3 is a schematic diagram of the pulse detection unit as part of Bob in the QKD system with Alice as illustrated in FIG. 2; and

FIG. 4 is an alternative embodiment of the pulse detection unit as part of Bob in the QKD system with Alice as illustrated in FIG. 2

The various elements depicted in the drawings are merely representational and are not necessarily drawn to scale. Certain sections thereof may be exaggerated, while others may be minimized. The drawings are intended to illustrate various embodiments of the invention that can be understood and appropriately carried out by those of ordinary skill in the art.

### DETAILED DESCRIPTION OF THE BEST MODE OF THE INVENTION

The present invention relates to quantum cryptography, and in particular relates to and has industrial utility in connection with quantum key distribution (QKD) systems.

### New Alice

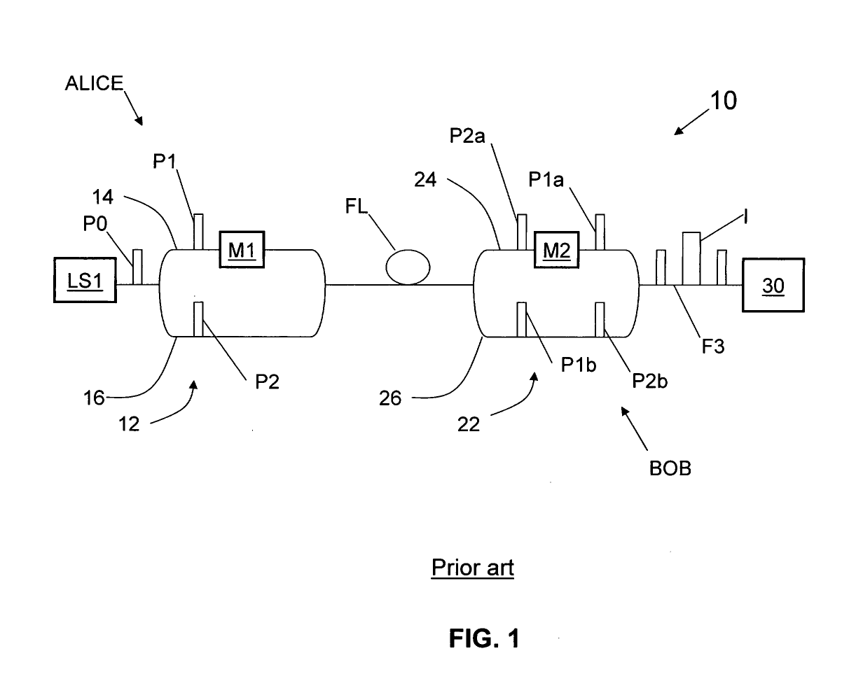

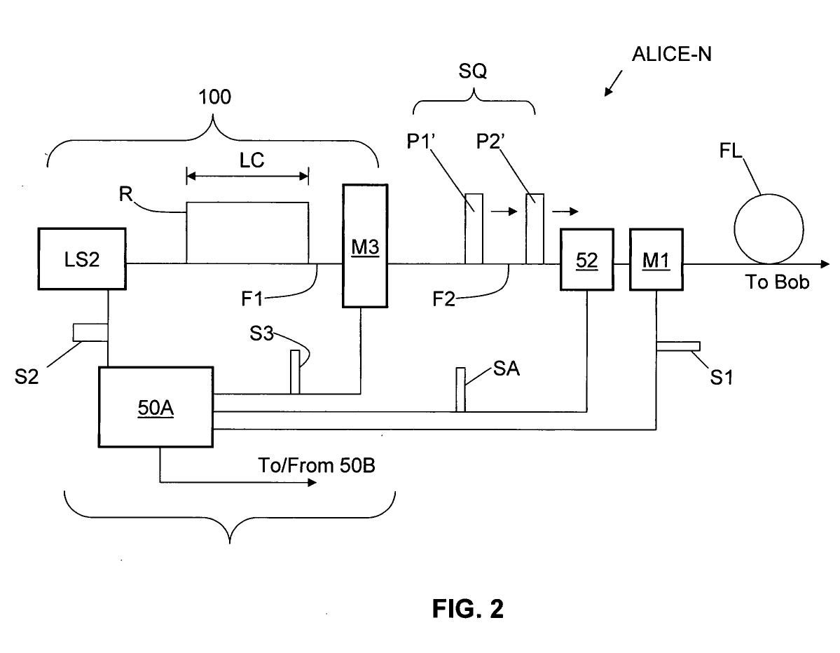

FIG. 2 is a close-up schematic diagram of a new Alice—called Alice N—for the QKD system of FIG. 1, wherein the interferometer loop 12 is replaced with an optical pulse generator 100. Optical Pulse generator 100 includes a laser source LS2 optically coupled (e.g., via an optical fiber section F1) to an intensity modulator M3. Modulator M1 is optically coupled (e.g., via optical fiber section F2) to and is downstream of modulator M3.

### The Laser Source

In an example embodiment, laser source LS2 is a continuous-wave (CW) laser that emits radiation R. In an example embodiment, laser source LS2 is a CW laser with coherence length complying with the requirements presented below. In an example embodiment, laser source LS2 has a coherence length LC on the order of nanoseconds (ns), e.g., in the range from about 1 ns to about 100 ns. Laser source LS2 may be, for example, a solid-state laser, such as an external-cavity diode laser.

There are other important requirements for the laser source coherence length and laser source frequency stabilization. To obtain interference, pulses P1′ and P2′ (discussed below) should be separated by a distance smaller than the laser source coherence length. The CW laser source LS2 should be frequency stabilized and have a narrow line width.

If Bob's interferometer 22 has a fiber length difference (for two arms) of ΔL, the phase difference Δφ between signals of two different frequencies is

Δφ=(2π/c)(ΔL)(Δf) (EQ. 1)

where c is the speed of light, and Δf is the difference between two frequencies. The difference in frequencies of the signals can arise, for example, from the laser source LS2 changing its output frequency because it is not properly frequency stabilized.

One can estimate the frequency stabilization requirements from EQ. 1, above. For example, for ΔL=1 m, and if from an interference extinction ratio phase difference is required to be about 1°, the laser frequency stability requirement is about

Δf<1 MHz. (EQ. 2)

### The Intensity Modulator

Also in an example embodiment, modulator M3 is a lithium niobate (LiNbO₃) modulator capable of rapidly switching on and off on a time scale on the order of tens to hundreds of picoseconds (ps). In another example embodiment, modulator M3 is an electro-absorption modulator. Modulator M3 preferably has a high extinction ratio so that it can create sharp optical pulses, as described below.

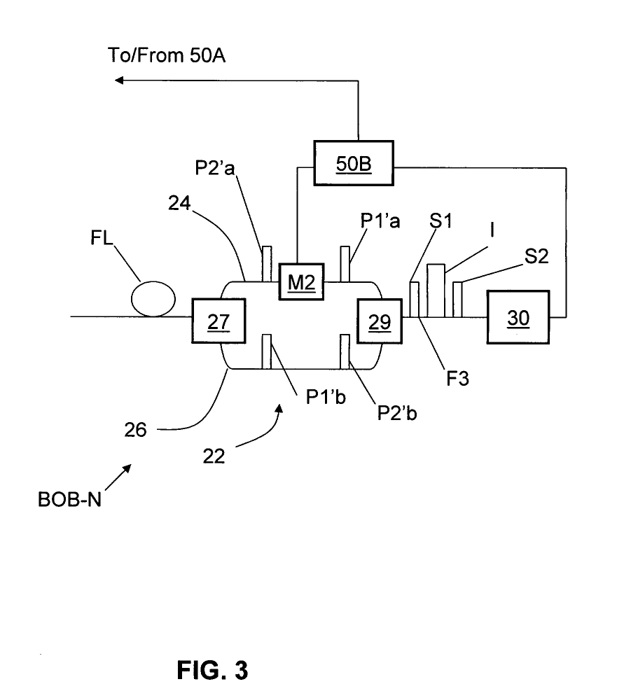

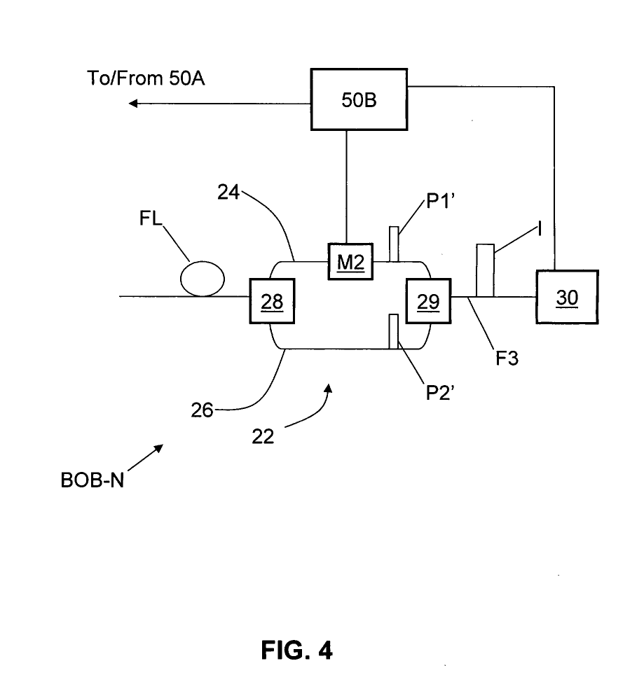

Modulator M3 is coupled to a controller 50A. Controller 50A is also coupled to laser source LS2 and to modulator M1. Alice-N also typically includes a variable optical attenuator (VOA) 52 coupled to the controller to ensure that pulses leaving Alice are weak (i.e., one photon or less on average). Controller 50A also acts to stabilize the frequency of laser source LS2. In addition, controller 50A is operably coupled to a controller 50B at Bob (FIGS. 3 and 4) so that the operation of the system as a whole is properly coordinated.

### Operation of the QKD System with the Alice-N

With continuing reference to FIG. 2, in operation controller 50A activates laser source LS2 via an activation signal S2. In response, laser source LS2 generates continuous laser radiation R. Laser radiation R is shown as a section of a CW beam, wherein the section has a coherence length LC.

Controller 50A sends a modulation signal S3 to modulator M3 to modulate radiation R. Modulator M3 modulates radiation R with sufficient speed (e.g., within the coherence length LC) and extinction to create two or more sharp, coherent radiation pulses. Two such pulses P1′ and P2′ are shown and discussed below for the sake of illustration.

In an example embodiment, pulses P1′ and P2′ have pulse widths ranging anywhere from 20 to 100 ps and are separated by intervals ranging from about 1 ns to 100 ns. Note that if arms 24 and 26 of Bob's interferometer differ in length by 10 cm, the corresponding pulse separation is 0.5 ns. Generally, the width and spacing of the pulses formed by modulator M3 are dictated by the gating pulse width of detector unit 30 and the requirement that the non-interfering pulses not overlap after leaving Bob's interferometer loop 22

Pulses P1′ and P2′ proceed to (phase) modulator M1, whose timing is coordinated with the operation of modulator M3 via signal S1 from controller 50A, so that modulator M1 selectively randomly modulates at least one of pulses P1′ and P2′. The two pulses are then attenuated by VOA 52 via an attenuation signal SA from controller 50A (if necessary). The pulses then proceed onto optical fiber link FL and travel over to Bob, where they are processed according to known QKD techniques. In an example embodiment, the one or more pulses formed in this manner constitute a quantum signal SQ.

From Bob's point of view, it is as if pulses P1′ and P2′ were created in the usual manner using an interferometer loop or the like. However, the advantage of using optical pulse generator 100 is that Alice-N no longer needs to be thermally stabilized to the high degree required for interferometer loops. This greatly reduces the cost and complexity of fabricating and maintaining a QKD system in working condition for long periods of time.

### New Bob

The present invention allows for new designs for Bob, referred as Bob-N. FIG. 3 is a schematic diagram of an example embodiment of Bob-N suitable for use with Alice-N of FIG. 2. In Bob-N of FIG. 3, elements 27 and 29 are each light splitting/combining elements, such as a coupler or a 50-50 beamsplitter. Also shown is Bob-N's controller 50B operably coupled to modulator M2 and to Alice-N's controller 50A.

In operation, after pulses P1′a, P1′b, P2′a and P2′b interfere at coupler 29, three pulses result: S1, I and S2, where the interfered pulse I is the result of the interference of pulses which followed the short-long and long-short paths. Interfered pulse I carries the modulation (phase) coding information from modulators M1 and M2. Optical side-pulses S1 and S2 are separated from the interfered central pulse I to avoid pulse overlapping during gating of detector unit 30. For example, if a gating pulse has a width of 2 ns, side peaks S1 and S2 should be a few nanoseconds away from each other. This dictates the tolerance on Bob's interferometer, i.e., the allowable mismatch in the optical path of arms 24 and 26 (approximately 5 ns pulse separation corresponds to 1 m).

FIG. 4 is a schematic diagram of another example embodiment Bob-N suitable for use with Alice-N as illustrated in FIG. 2 In Bob-N of FIG. 4, element 28 is a fast optical switch that is fast enough to switch between pulses P1′ and P2′. The first incoming pulse is routed to a longer arm of interferometer and the second incoming pulse is routed to the shorter arm. After pulses P1′ and P2′ interfere at element 29, only one interference peak (signal) I appears. The advantage of using optical switch for element 28 is that Bob's interferometer arm length difference can be made very small, e.g., small enough for an integrated waveguide form design for the interferometer 22. This simplifies interferometer stabilization (e.g., for thermal and mechanical drifts) and laser frequency stabilization at Bob-N.

### Example Interferometer Balancing Method

The present invention includes methods for balancing arms 24 and 26 of interferometer 22. The method includes generating the optical pulses P1′ and P2′ at Alice-N as discussed in detail above and sending them to interferometer 22 at Bob-N. The method then includes measuring the interference of pulses exiting interferometer 22, e.g., the interference between pulses P2′a and P2′b at detector unit 30. The method further includes adjusting the modulation of the CW radiation R, and optionally adjusting the delay between two pulses, as well as the pulse amplitudes, based on the measurement at detector unit 30. This is done in order to obtain a desired measurement at detector unit 30, or a desired interference at the output of interferometer 22. This feedback technique is made possible by the operable connection between controllers 50A and 50B of Alice-N and Bob-N, respectively.

A QKD system based on present invention preferably employs a form of polarization control at Bob's interferometer 22 (i.e., after fiber propagation), such as shown in Townsend patent. Also in an example embodiment, Bob's interferometer is thermally stabilized with a feed-back loop. An example of a thermal stabilization feedback loop for a QKD system is described in U.S. patent application Ser. No. 10/882,013, entitled “Temperature compensation for QKD systems,” which patent application is incorporated by reference herein.

1. A method of generating two or more coherent optical pulses in a first station of a QKD system, comprising:
generating a continuous wave (CW) beam of coherent radiation having a coherence length LC;
modulating the CW beam within the coherence length LC so as to create first and second coherent optical pulses of radiation;
selectively randomly phase- or polarization-modulating one of first and second coherent optical pulses; and
sending the two or more coherent optical pulses of radiation as weak pulses to a second QKD station optically coupled to the first QKD station.

2. The method of claim 1, further including at the second QKD station:
selectively randomly phase- or polarization-modulating one of the first and second coherent optical pulses;
interfering the first and second coherent optical pulses to form an interfered signal; and
detecting the interfered pulse.

3. A first QKD station for a QKD system, comprising:
a laser source adapted to emit a continuous wave (CW) beam of radiation having a coherence length LC;
a first modulator optically coupled to the laser source and adapted to modulate the radiation beam within the coherence length LC to create pairs of coherent optical pulses; and
a second modulator downstream of the first modulator and optically coupled thereto, the second modulator adapted to selective randomly modulate at least one optical pulse of each pair of coherent optical pulses so as to create a modulated quantum signal adapted to be selectively randomly modulated and detected at a second QKD station optically coupled to the first QKD station.

4. The QKD station of claim 3, further including a controller operably coupled to and adapted to control and coordinate the operation of the laser source, the first modulator and the second modulator.

5. The QKD station of claim 3, further including an optical attenuator arranged to ensure that the two or more coherent optical pulses are weak prior to traveling to another QKD station.

6. A method of balancing first and second arms of an interferometer, comprising:
generating a continuous wave (CW) beam of coherent radiation having a coherence length LC;
modulating the CW beam within the coherence length LC so as to create two or more coherent optical pulses of radiation;
sending the two or more coherent optical pulses to the interferometer; and
adjusting said modulating to obtain a desired interference at an output end of the interferometer.

7. The method of claim 6, wherein adjusting the modulating includes:
measuring with a detector unit an interference created by the interferometer;
communicating the measurement to a first controller operably coupled to the detector unit;
communicating the measurement to a second controller operably coupled to the first controller and operably coupled to a modulator; and
directing the second controller to adjust the modulator based on the measurement made by the detector unit.
